(19) United States
(12) Patent Application Publication
(10) Pub. No.: US 2006/0047395 A1
(43) Pub. Date: Mar. 2, 2006

(54) Method and device for controlling gear shift of mechanical transmission

(75) Inventors: Kouichi Ikeya, Tokyo (JP); Kazunobu Eritate, Tokyo (JP); Toshikuni Shirasawa, Tokyo (JP)

Correspondence Address: BIRCH STEWART KOLASCH & BIRCH, PO BOX 747, FALLS CHURCH, VA, 22040-0747, US

(73) Assignee: Mitsubishi Fuso Truck And Bus Corporation, Tokyo (JP)

(21) Appl. No.: 10/533,448

(22) PCT Filed: Nov. 7, 2003
(86) PCT No.: PCT/JP03/14180

§ 371 Date: May 2, 2005

(30) Foreign Application Priority Data
Nov. 8, 2002 (JP) 2002-325386

(51) Int. Cl. G06F 17/00

(52) U.S. Cl. 701/51; 701/56

(57) ABSTRACT

Provided are a transmission control method for a mechanical transmission, capable of shortening a gear shift time without undergoing a shock attributed to gear disengagement, and an apparatus therefor. The transmission control apparatus comprises engine torque control means (S10) for controlling an engine torque generated by an internal combustion engine so that the value of a transfer torque of a friction clutch is 0 or near 0 when a gear shift of the mechanical transmission is required, gear shift allowing means (S12) for aloowing the gear shift of the mechanical transmission when the engine torque is controlled by the engine torque control means so that the value of the transfer torque is 0 or near 0, and gear shift executing means (S16) for disengaging and engaging gears with the clutch kept connected when the gear shift is allowed by the gear shift allowing means.

### TECHNICAL FIELD

The present invention relates to a method and an apparatus for transmission control for a mechanical transmission, and more specifically, to a technique for performing a gear shift without connecting or disconnecting a friction clutch.

### BACKGROUND ART

Transmissions of which gear shift operation is automated are frequently used as vehicular transmissions. In large vehicles, such as buses, trucks, etc., the transfer amount of driving torque is so large that it is hard for a torque converter to transfer the driving torque satisfactorily. For example, a mechanical transmission, which is designed so that gear shift operation for a manual mechanical transmission is automated, is employed.

This mechanical transmission is configured to achieve a gear shift by automatically carrying out gear engagement and gear disengagement. As for a friction clutch, it is configured to be automatically connected and disconnected in accordance with the gear shift or a stop of the vehicle.

In automatically controlling the friction clutch in accordance with the gear shift in the mechanical transmission, however, delicate control in a half-clutched state is difficult. Therefore, the time during which the friction clutch is disconnected so that no driving force can be transmitted to wheels is long, and the period of execution of the gear shift may be felt long.

On the other hand, a technique is devised so that fuel supply to an internal combustion engine is repeatedly adjusted as a dog clutch of the transmission is disengaged, whereby a transfer torque is cut off so that the dog clutch can be disengaged satisfactorily (e.g., see Japanese Patent Publication No. 1-164633 (Japanese Patent No. 2887481), hereinafter referred to as patent document 1).

In consideration of the patent document 1 described above, a gear shift can be achieved without disconnecting the friction clutch in the mechanical transmission.

According to the foregoing patent document 1, however, the dog clutch is urged to be disengaged as the fuel supply to the internal combustion engine is adjusted, and the point of time when the dog clutch is disengaged, i.e. the time of gear disengagement is not clear. In other words, the timing for the gear disengagement is not fixed according to the patent document 1. Therefore, it can be supposed that, depending on the engine torque of the internal combustion engine varying with the increase or decrease of the fuel supply, the gear disengagement is performed inevitably even if the transfer torque is not fully cut off, in many cases.

If the gear disengagement is performed in this manner without fully cutting off the transfer torque, and if the transfer torque is relatively high, a shock is generated by the gear disengagement, unfavorably giving a feeling of wrongness to occupants of the vehicle.

### DISCLOSURE OF THE INVENTION

The present invention has been made in order to solve these problems, and its object is to provide a transmission control method for a mechanical transmission, capable of shortening a gear shift time without undergoing a shock attributed to gear disengagement, and an apparatus therefor.

In order to achieve the above object, according to the present invention, a transmission control method for a mechanical transmission, capable of transmitting an output of an internal combustion engine to wheels through a friction clutch by performing automatic multistage speed change, comprises a step (a) of controlling an engine torque generated by the internal combustion engine in response to a request for a gear shift of the mechanical transmission so that the value of a transfer torque of the friction clutch is 0 or near 0, a step (b) of allowing the gear shift of the mechanical transmission when the engine torque is controlled so that the value of the transfer torque is 0 or near 0 in the step (a), and a step (c) of disengaging and engaging gears with the clutch kept connected when the gear shift is allowed in the step (b).

According to the transmission control method of the present invention, the engine torque is controlled in response to the request for a gear shift. If the value of the transfer torque of the friction clutch is 0 or near 0, therefore, the gears are disengaged and engaged with the clutch kept connected, so that the gear shift can be achieved in a short time without undergoing a shock attributed to the gear disengagement.

In the present invention, the step (c) may include a sub-step (c1) of changing an engine revolution speed of the internal combustion engine after the gear disengagement is performed with the clutch kept connected and a sub-step (c2) of performing the gear engagement for a gear stage after the gear shift with the clutch kept connected when the engine revolution speed is substantially synchronous with a gear revolution speed for the gear stage after the gear shift. When the gear disengagement is performed, in this preferred aspect, the engine revolution speed is changed to be synchronous with the gear revolution speed for the gear stage after the gear shift, so that the gear engagement can be carried out smoothly with no rotational speed difference without connecting or disconnecting the clutch.

In the transmission control method of the present invention, moreover, the applicable mechanical transmission is configured so that the friction clutch can be automatically connected and disconnected, and the step (c) may include automatically disconnecting the friction clutch to disengage and engage the gears if gear disengagement is not executed after a command for gear disengagement is issued. If the gear disengagement fails to be executed despite the issuance of the command for gear disengagement, in this preferred aspect, the gear disengagement and gear engagement can be performed securely with the friction clutch disconnected, and the gear shift can be executed securely.

In the transmission control method of the present invention, the step (a) may include obtaining a changed engine torque such that the value of the transfer torque is 0 or near 0 in accordance with a first motion equation for a range from the internal combustion engine to the friction clutch and a second motion equation for a range from the friction clutch to each wheel and a position on an axle shaft of a vehicle, indicating the changed engine torque, and controlling the internal combustion engine so that the changed engine torque is generated. Further, the first or second motion equations are transformed on condition that an engine rotation angle acceleration on the axle shaft is equal to an axle shaft rotation angle acceleration on the axle shaft, and the step (a) may include obtaining the changed engine torque in accordance with the transformed first or second motion equation so that the value of the transfer torque is 0. In a preferred aspect such that the friction clutch has a flywheel and a clutch plate capable of being connected to and disconnected from the flywheel, a motion equation for a range from the internal combustion engine to the flywheel may be used as the first motion equation, and a motion equation for a range from the clutch plate to each wheel and a position on the axle shaft may be used as the second motion equation.

Moreover, the step (a) may include concluding that the value of the transfer torque is 0 or near 0 after the lapse of a predetermined period since the indication of the changed engine torque.

The internal combustion engine may include a fuel injection pump unit having a control rack for adjusting a fuel injection quantity. In this preferred aspect, the step (a) may include controlling the control rack, thereby controlling the engine torque, and the step (b) may include determining whether or not the value of the transfer torque is 0 or near 0 based on the position of the control rack.

The internal combustion engine may have an auxiliary brake. In this preferred aspect, the sub-step (c1) may include actuating the auxiliary brake if the engine revolution speed of the internal combustion engine exceeds an upper limit value of a predetermined revolution speed range including a target engine revolution speed corresponding to the gear revolution speed.

Moreover, the sub-step (c1) may include correcting a target engine revolution speed corresponding to the gear revolution speed in accordance with the characteristics of the internal combustion engine.

Furthermore, the step (c) may include issuing a command to restore the engine torque after the lapse of a predetermined period since the start of gear engagement, when a gear shift from a high-speed stage to a low-speed stage of the mechanical transmission is required by the gear shift request.

In order to achieve the above object, a transmission control apparatus for a mechanical transmission according to the present invention, capable of transmitting an output of an internal combustion engine to wheels through a friction clutch by performing automatic multistage speed change, comprises engine torque control means for controlling an engine torque generated by the internal combustion engine so that the value of a transfer torque of the friction clutch is 0 or near 0 when a gear shift of the mechanical transmission is required, gear shift allowing means for allowing the gear shift of the mechanical transmission when the engine torque is controlled by the engine torque control means so that the value of the transfer torque is 0 or near 0, and gear shift executing means for disengaging and engaging gears with the clutch kept connected when the gear shift is allowed by the gear shift allowing means.

When the gear shift of the mechanical transmission is required, therefore, the engine torque generated by the internal combustion engine is controlled by the engine torque control means so that the value of the transfer torque is 0 or near 0. If the value of the transfer torque reaches 0 or near 0, the gear shift is allowed by the gear shift allowing means, and the gear disengagement and gear engagement are performed with the clutch kept connected by the gear shift executing means.

Thus, when the value of the transfer torque securely reaches 0 or near 0, the gear disengagement can be performed without connecting or disconnecting the clutch, and therefore, the gear shift time can be shortened so that the gear shift can be quickly achieved without undergoing a shock attributed to the gear disengagement.

Moreover, the transmission control apparatus for a mechanical transmission according to the present invention may further comprise engine revolution speed detecting means for detecting an engine revolution speed of the internal combustion engine and gear revolution speed detecting means for detecting a gear revolution speed for a gear stage after the gear shift. In this preferred aspect, the gear shift executing means changes the engine revolution speed of the internal combustion engine after the gear disengagement is performed with the clutch kept connected and performs the gear engagement for the gear stage after the gear shift with the clutch kept connected when the engine revolution speed is substantially synchronous with the gear revolution speed for the gear stage after the gear shift.

When the gear disengagement is performed, in the preferred aspect described above, the engine revolution speed of the internal combustion engine is changed to be synchronous with the gear revolution speed for the gear stage after the gear shift, so that the gear engagement can be carried out smoothly with no rotational speed difference without connecting or disconnecting the clutch.

In the transmission control apparatus for a mechanical transmission according to the present invention, furthermore, the friction clutch may be configured to be able to be automatically connected and disconnected. In this preferred aspect, the gear shift executing means automatically disconnects the friction clutch to disengage and engage the gears if gear disengagement is not executed after a command for gear disengagement is issued.

If the gear disengagement fails to be executed despite the issuance of the command for gear disengagement by the gear shift executing means, in the preferred aspect described above, the gear disengagement and gear engagement can be performed securely with the friction clutch disconnected, and the gear shift can be executed securely.

In the transmission control apparatus of the present invention, the friction clutch may have a flywheel and a clutch plate capable of being connected to and disconnected from the flywheel. In this preferred aspect, the engine torque control means can obtain a changed engine torque such that the value of the transfer torque is 0 or near 0 in accordance with a first motion equation for a range from the internal combustion engine to the flywheel and a second motion equation for a range from the friction clutch to each wheel and a position on an axle shaft of a vehicle and control the internal combustion engine so that the changed engine is generated.

Further, the internal combustion engine may include a fuel injection pump unit having a control rack for adjusting a fuel injection quantity. In this preferred aspect, the engine torque control means can control the control rack, thereby controlling the engine torque.

Furthermore, the internal combustion engine may have an auxiliary brake. In this preferred aspect, the gear shift executing means actuates the auxiliary brake if the engine revolution speed of the internal combustion engine exceeds an upper limit value of a predetermined revolution speed range including a target engine revolution speed corresponding to the gear revolution speed.

### BRIEF DESCRIPTION OF THE DRAWINGS

FIG. 1 is a schematic diagram of a drive system of a vehicle (bus or the like) to which a transmission control apparatus for a mechanical transmission according to the present invention is applied;

FIG. 2 is a part of a flowchart showing a control routine of clutchless shift control according to a first embodiment of the present invention;

FIG. 3 is the remainder of the flowchart continued from FIG. 2, showing the control routine of the clutchless shift control according to the present invention;

FIG. 4 is a flowchart showing a control routine of Ne-F/B control of FIG. 2;

FIG. 5 is the remainder of the flowchart continued from FIG. 3, showing the control routine of the clutchless shift control according to the present invention; and

FIG. 6 is a part of a flowchart showing a control routine of clutchless shift control according to a second embodiment of the present invention.

### BEST MODE FOR CARRYING OUT THE INVENTION

An embodiment of the present invention will now be described with reference to the drawings.

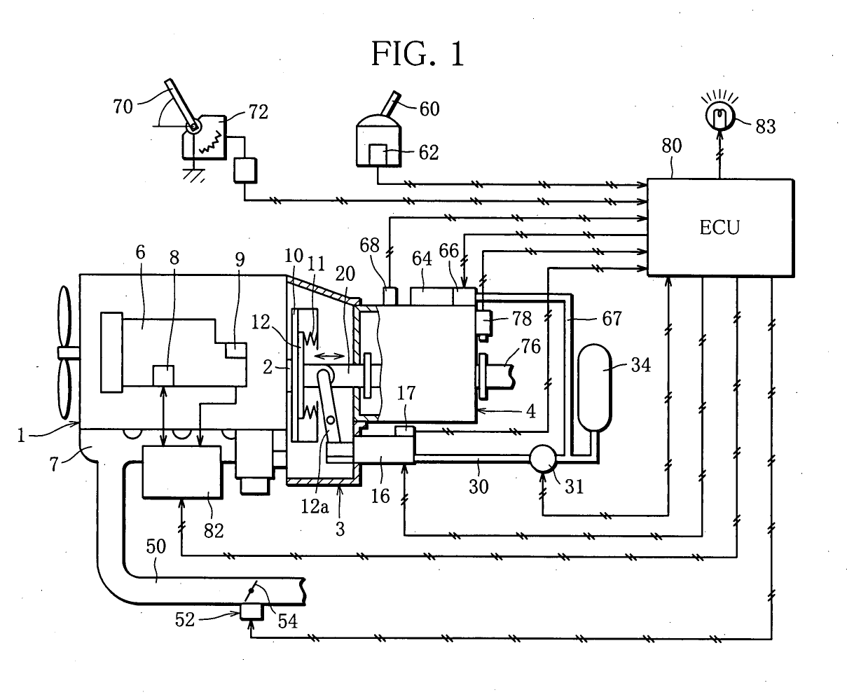

FIG. 1 shows an outline of a drive system of a vehicle (bus or the like) to which a transmission control apparatus for a mechanical transmission according to the present invention is applied. Referring now to FIG. 1, there will be described a configuration of the drive system of the vehicle that includes the transmission control apparatus for the mechanical transmission according to the present invention.

As shown in the figure above, a diesel engine (hereinafter referred to as engine) 1 is provided with a fuel injection pump unit (hereinafter referred to as injection pump) 6 for supplying a fuel. The injection pump 6 is a device that injects the fuel by actuating a pump with an output of the engine 1 transmitted through a pump input shaft (not shown). The injection pump 6 is provided with a control rack (not shown) for adjusting the fuel injection quantity and a rack position sensor 9 for detecting a rack position (control rack position) SRC of the control rack. Further, an engine revolution speed sensor (engine revolution speed detecting means) 8 for detecting the rotational frequency of the pump input shaft and detecting the rotational frequency of an engine output shaft 2, that is, an engine revolution speed Ne, in accordance with the foregoing rotational frequency is attached near the pump input shaft.

The engine output shaft 2 extends from the engine 1. This engine output shaft 2 is connected to an input shaft 20 of a gear transmission (hereinafter referred to as transmission) through a clutch unit 3. Thus, the output of the engine 1 is transmitted to the transmission 4, whereupon a speed change is executed in the transmission 4. The transmission 4 is a mechanical transmission that has, for example, five forward gear change stages (first to fifth gear change stages), besides a reverse gear stage, and can perform a manual gear shift as well as an automatic gear shift. The clutch unit 3 is constructed so that the transmission 4 can be automatically controlled to be connected to and disconnected from the engine 1 when the vehicle is stopped or started. In some cases, the clutch unit 3 may be automatically controlled for connection and disconnection at the time of an automatic gear shift, as described after.

The clutch unit 3 enables automatic execution of operation of a conventional mechanical-friction clutch such that a connected state is established by pressing a clutch plate 12 against a flywheel 10 by means of a pressure spring 11 or that a disconnected state is established by separating the clutch plate 12 from the flywheel 10. The clutch plate 12 can be automatically operated by a clutch actuator for clutch connection and disconnection, that is, a clutch actuator 16, aided by an outer lever 12a.

More specifically, the clutch actuator 16 is connected with an air tank 34 by an air passage 30 as an air supply passage. Thus, when operation air from the air tank 34 is supplied through the air passage 30, the clutch actuator 16 is actuated automatically. Thereupon, the clutch plate 12 moves, and the clutch unit 3 is connected or disconnected automatically.

Actually, the air passage 30 is fitted with an electropneumatic proportional control valve 31, which is driven, in response to a signal from an electronic control unit (ECU) 80, to allow and cut off circulation of the operation air. If a drive signal is supplied from the ECU 80 to the electropneumatic proportional control valve 31, the operation air is supplied from the air tank 34 to the clutch actuator 16 through the electropneumatic proportional control valve 31, whereupon the clutch actuator 16 is actuated to disconnect the clutch unit 3. If the supply of the drive signal is stopped, on the other hand, the operation air supply from the air tank 34 to the clutch actuator 16 is interrupted, and the working air in the clutch actuator 16 is discharged into the atmosphere. Thereupon, the clutch unit 3 is connected by the agency of the pressure spring 11.

The clutch actuator 16 is fitted with a clutch stroke sensor 17 that detects a movement of the clutch plate 12, i.e. a clutch stroke.

A change lever 60 is a select lever of the transmission 4 and is provided with an N (neutral) range, R (reverse) range, and D (drive) range that corresponds to an automatic gear shift mode.

The change lever 60 is provided with a select position sensor 62 that detects each range position. This select position sensor 62 is connected to the ECU 80. On the other hand, the ECU 80 is connected to a gear shift unit 64 for switching the engagement of gears of the transmission 4, that is, a gear position. When a position signal is supplied from the select position sensor 62 to the ECU 80, therefore, a drive signal is delivered from the ECU 80 to the gear shift unit 64 in response to the position signal. Thereupon, the gear shift unit 64 is actuated to shift the gear position of the transmission 4 to a selected desired select range. If the select position is in the D range, automatic transmission control is executed depending on the driving state of the vehicle, which will be described in detail later, and the gear position is shifted under this automatic transmission control.

The gear shift unit 64 includes a solenoid valve 66, which is actuated by an operation signal from the ECU 80, and a power cylinder (not shown) that actuates a shift fork (not shown) in the transmission 4. The power cylinder is connected to the air passage 30 through the solenoid valve 66 and an air passage 67. Thus, when the operation signal from the ECU 80 is applied to the solenoid valve 66, the solenoid valve 66 is opened or closed in response to the operation signal, and the power cylinder is actuated by the operation air supply from the air tank 34. Thereupon, the engagement of the gear of the transmission 4 is suitably changed by, for example, a racing gear. Only one solenoid valve 66 is illustrated in this case. Actually, however, a plurality of shift forks are arranged, a plurality of power cylinders are provided corresponding to the shift forks, and a plurality of solenoid valves 66 are provided corresponding to the power cylinders.

A gear position sensor 68 for detecting each gear stage is attached near the gear shift unit 64 of the transmission 4 and connected electrically to the ECU 80. A current gear position signal, i.b. gear stage signal is delivered from the gear position sensor 68 to the ECU 80.

An accelerator pedal 70 is provided with an accelerator opening sensor 72 and also connected electrically to the ECU 80. An amount of depression of the accelerator pedal 70, that is, accelerator opening information θacc, is outputted from the accelerator opening sensor 72.

Further, an output shaft 76 of the transmission 4 is provided with a revolution speed sensor 78 that detects and outputs the revolution speed of the output shaft 76, and this revolution speed sensor 78 is also connected electrically to the ECU 80. A vehicle speed V is calculated in the ECU 80 in accordance with information from the revolution speed sensor 78.

In FIG. 1, numeral 82 denotes an engine control unit 82 that is provided independently of the ECU 80. The engine control unit 82 is a device that supplies an electronic governor (not shown) in the injection pump 6 with a signal from the ECU 80, corresponding to information from each sensor, the accelerator opening information θacc, etc., and controls the drive of the engine 1. More specifically, if a command signal is supplied from the engine control unit 82 to the electronic governor, the control rack is actuated to carry out fuel increasing or decreasing operation, and the increase or decrease of an engine torque Te or the engine revolution speed Ne is controlled. Detection information from the rack position sensor 9 and the engine revolution speed sensor 8 is supplied to the ECU 80 through the engine control unit 82.

Further, an exhaust pipe 50 extending from an exhaust manifold 7 of the engine 1 is provided with an exhaust brake 52. The exhaust brake 52, which is composed of a butterfly valve 54, is connected to the ECU 80 and configured to be able to adjust the exhaust flow rate by closing the butterfly valve 54 in response to a command from the ECU 80. Thus, the engine output and the engine revolution speed Ne are reduced, so that a braking force is applied to the vehicle.

The ECU 80 is composed of a microcomputer (CPU), a memory, interfaces for input/output signal processing, etc. As mentioned before, an input-side interface of the ECU 80 are connected with the clutch stroke sensor 17, select position sensor 62, gear position sensor 68, accelerator opening sensor 72, revolution speed sensor 78, engine control unit 82, etc.

On the other hand, an output-side interface of the ECU 80 is connected with a warning lamp 83, as well as the solenoid valve 66, engine control unit 82, clutch actuator 16, exhaust brake 52, etc. mentioned before.

The following is a description of transmission control of the transmission control apparatus for the mechanical transmission according to the present invention constructed in this manner.

A first embodiment will be described first.

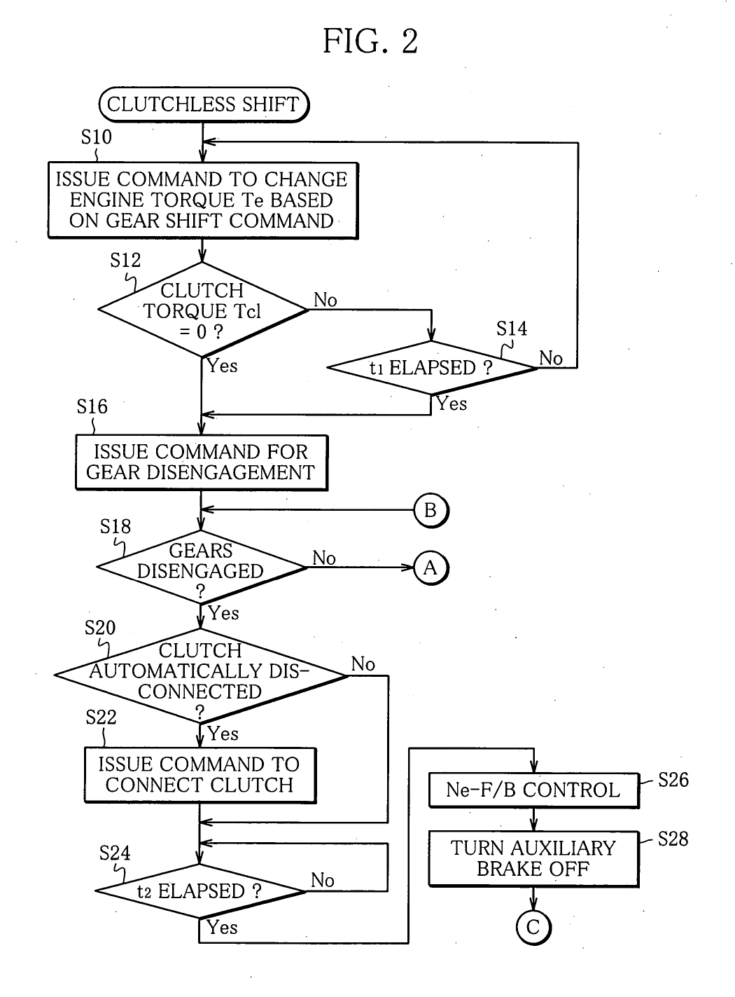

Referring now to FIGS. 2 to 5, there is shown a flow chart for control routines of clutchless shift control according to the present invention, and the following description is based on this flowchart.

In Step S10 of FIG. 2, a command is issued to change the engine torque Te (engine torque control means) in response to a gear shift command from the ECU 80. More specifically, in doing this, the engine 1 is controlled to change the engine torque Te so that the value of a transfer torque of the clutch unit 3, i.e. a clutch torque Tcl between the flywheel 10 and the clutch plate 12, is 0 or near 0.

More specifically, the engine torque Te to be changed is obtained as follows so that the value of the clutch torque Tcl is, for example, 0, according to a motion equation (equation (1)) for a range from the engine 1 to the flywheel 10 and a motion equation (equation (2)) for a range from the clutch plate 12 to each wheel and a position on an axle shaft of the vehicle:

$$\begin{matrix}( Te - Tcl ) \cdot it \cdot if = Ie \cdot {it}^{2} \cdot {if}^{2} \cdot {d}^{2} θ e / ⅆ {t}^{2} , & ( 1 ) \\ Tcl \cdot it \cdot if - ( W ( μ + sin θ ) + λ {AV}^{2} ) R η = ( W / g \cdot {R}^{2} + ( Iw + ( If + It \cdot {it}^{2} ) \cdot {if}^{2} ) ) \cdot {d}^{2 } θ ax / {dt}^{2} . & ( 2 )\end{matrix}$$

The parameters are:
g: gravitational acceleration,
η: power transfer efficiency,
μ: rolling resistance coefficient,
λ: air resistance coefficient,
Ie: moment of inertia of rotating portion of engine input shaft
It: moment of inertia of transmission
If: moment of inertia of rotating portion of differential gear input shaft
Iw: moment of inertia of axle and same rotating portion
it: transmission gear ratio
if: differential gear ratio
W: vehicle weight
A: front projection area
R: wheel radius
Te: engine torque (on input shaft of transmission)
Tcl: clutch torque (on input shaft of transmission)
V: vehicle speed
d²θe/dt²: engine rotation angular acceleration (on axle shaft)
d²θax/dt²: axle shaft rotation angular acceleration (on axle shaft)

If the value of the clutch torque Tcl is adjusted to, for example, 0, in this case, d²θe/dt²=d²θax/dt² is obtained, so that the equations (1) and (2) can be transformed into equations (3) and (4) as follows:
Te·it·if=I1·d²θe/dt², (3)
−(W(μ+sin θ)+λAV²)Rη=(I2+I3)·d²θe/dt². (4)

Here I1, I2 and I3 are I1=Ie·it²·if² (inertia of engine), I2=(Iw+(If+It·it²)·if²) (inertia of rotating portion), and I3=W/g·R² (inertia corresponding to vehicle weight), respectively.

Thus, if d²θe/dt² is eliminated, the engine torque Te can be obtained according to the following equation (5):
Te=(−(W(μ+sin θ)+λAV²)Rη/(it·if))·I1(I2+I3). (5)

If the engine torque Te is given in this manner, the control rack is controlled so that the engine torque Te can be obtained, whereby the fuel injection quantity is changed.

In the following Step S12, it is determined whether or not the value of the clutch torque Tcl is 0 (zero) or near 0. Here it is determined whether or not the actual engine torque Te is substantially equal to the engine torque Te that is obtained from the equation (5). More specifically, it is determined whether or not a desired rack position is reached by the rack position SRC in accordance with the information from the rack position sensor 9. Alternatively, a torque sensor may be provided to directly detect that the value of the clutch torque Tcl is 0 (zero) or near 0.

The program proceeds to Step S16 (gear shift allowing means) if the decision in Step S12 is positive (Yes), that is, if it is concluded that the desired rack position is reached by the rack position SRC and that the value of the clutch torque Tcl is 0 or near 0. On the other hand, the program proceeds to Step S14 to continue changing the fuel injection quantity until a predetermined period t1 elapses after the issuance of the command to change the engine torque Te if the decision in Step S12 is negative (No), that is, if it is concluded that the desired rack position is not reached by the rack position SRC and that the value of the clutch torque Tcl is not yet 0 or near 0.

In Step S14, the predetermined period t1 is a time corresponding to a response delay of the control rack, for example. If the predetermined period t1 is found to have elapsed, the value of the clutch torque Tcl can be regarded to have reached 0 or near 0. Thus, if the decision in Step S14 is positive (Yes), that is, if the predetermined period t1 is concluded to have elapsed, the program proceeds to Step S16 in the same manner as aforesaid.

In Step S16, a command is issued to disengage the gears of the transmission 4 (gear shift executing means). If the value of the clutch torque Tcl is 0 or near 0, as mentioned before, no transfer torque is produced between the flywheel 10 and the clutch plate 12 or between the gears of the transmission 4, so that the gears should be able to be easily disengaged without any shock although the clutch unit 3 is not disconnected. Thus, in this case, the gears are disengaged by means of the gear shift unit 64 with the flywheel 10 and the clutch plate 12 kept connected to each other without disconnecting the clutch unit 3.

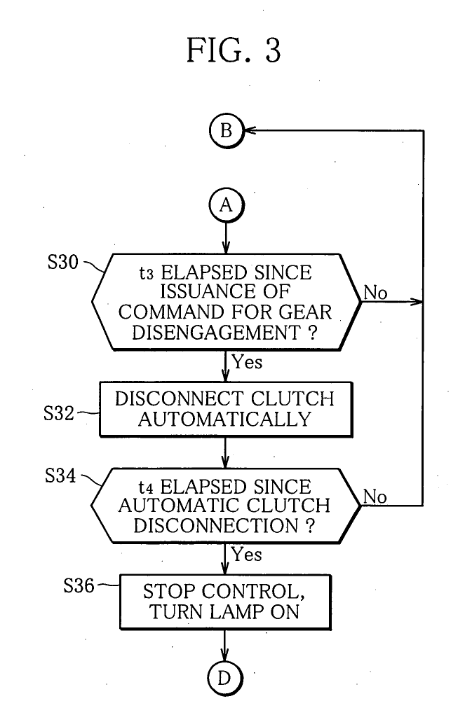

In Step S18, it is determined whether or not the gears are disengaged. In this case, it is determined whether or not the gears are disengaged to establish a neutral state in the transmission 4 in accordance with information from the gear position sensor 68. If the decision is negative (No), that is, if it is concluded that the gears are not disengaged, the program proceeds to Step S30 of FIG. 3.

In Step S30, it is determined whether or not a predetermined period t3 has elapsed since the issuance of the command to disengage the gears. The predetermined period t3 is a time that exceeds a response delay of the shift fork, for example. Normally, the gears should be disengaged before the lapse of the predetermined period t3. If the decision is negative (No), that is, before the lapse of the predetermined period t3, therefore, the determination of Step S18 is continued to wait the disengagement of the gears.

If the decision in Step S30 is positive (Yes), that is, if the predetermined period t3 is concluded to have elapsed, on the other hand, the gears may be supposed to be unreleasable with the clutch unit 3 left connected, for some reason. This may, for example, be a situation where the parameters in the equation (5) are so inaccurate that the engine torque Te cannot be obtained correctly or a situation where the rack position sensor 9 has a failure. In this case, therefore, the program proceeds to Step S32, in which the clutch actuator 16 is actuated to automatically disconnect the clutch unit 3 (automatic declutching), and the program proceeds to Step S34.

In Step S34, it is determined whether or not a predetermined period t4 has elapsed since the automatic disconnection of the clutch unit 3. The predetermined period t4 is a time that exceeds a response delay of the clutch actuator 16, for example. Normally, the clutch unit 3 should be disconnected to allow the gears to be disengaged before the lapse of the predetermined period t4. If the decision is negative (No), that is, before the lapse of the predetermined period t4, therefore, the determination of Step S18 is continued to wait the disengagement of the gears.

If the decision in Step S34 is positive (Yes), that is, if the predetermined period t4 is concluded to have elapsed, on the other hand, the gear disengagement itself may be supposed to be unattainable for some reason. In this case, therefore, the transmission 4 is concluded to be out of order, whereupon the program proceeds to Step S36, in which the entire automatic transmission control is stopped, and the warning lamp 83 is turned on to inform a driver of the trouble.

If the decision in Step S18 is positive (Yes), that is, if the gears are concluded to have been disengaged, the program proceeds to Step S20.

In Step S20, it is determined whether or not the clutch unit 3 is disconnected automatically. If the decision is negative (No), that is, if the clutch unit 3 is not disconnected automatically, the program proceeds to Step S24. If the clutch unit 3 is disconnected automatically in the aforesaid manner, on the other hand, the decision is positive (Yes). In this case, the program proceeds to Step S24 after the clutch unit 3 is connected in Step S22.

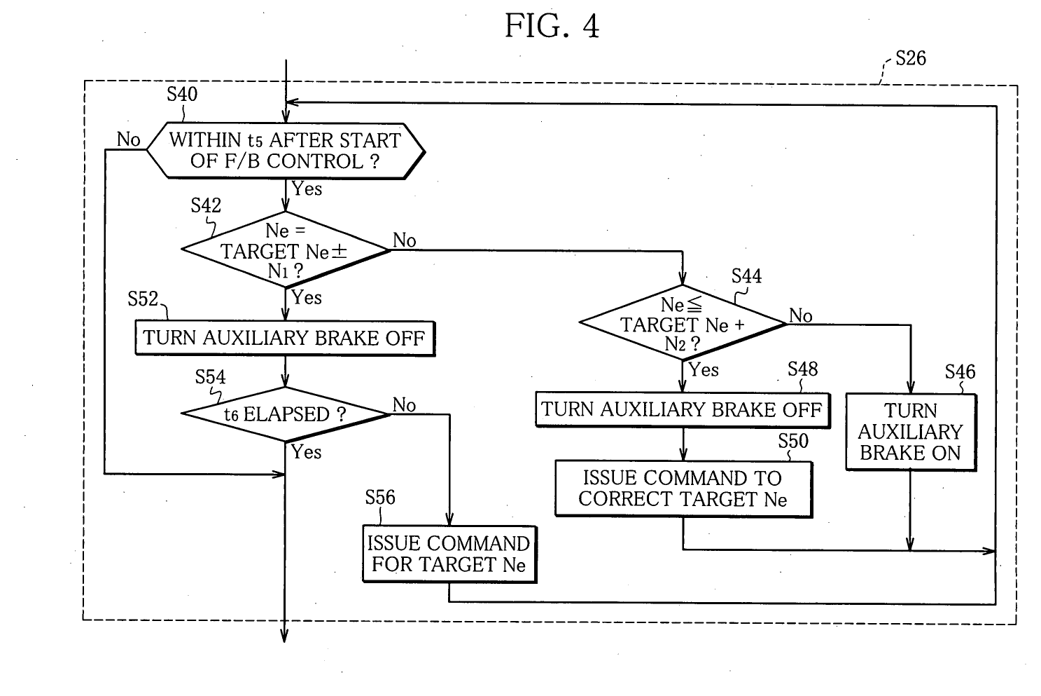

In Step S24, the lapse of the predetermined period t2 is awaited. In Step S26, thereafter, feedback control (Ne-F/B control) of the engine revolution speed Ne is carried out in Step S26. In this Ne-F/B control, as shown in the subroutine in FIG. 4, the engine revolution speed Ne is substantially synchronized with a gear revolution speed for a gear stage after the gear shift.

In the Ne-F/B control, it is determined whether or not the time that has elapsed since the start of the NE-F/B control is within a predetermined period t5 in Step S40. Immediately after the start of the Ne-F/B control, the decision is positive (Yes), so that the program proceeds to Step S42.

In Step S42, it is determined whether or not the engine revolution speed Ne is near the gear revolution speed for the gear stage after the gear shift, that is, a target Ne (Ne=target Ne±N1). The gear revolution speed for the gear stage after the gear shift, that is, the target Ne, can be easily calculated from the revolution speed of the output shaft 76, which is detected by the revolution speed sensor 78, and the gear ratio (gear revolution speed detecting means). If the decision is negative (No), that is, if it is concluded that the engine revolution speed Ne is not equal to or near the target Ne after the gear shift, the program proceeds to Step S44.

In Step S44, it is determined whether or not the engine revolution speed Ne is within a revolution speed range such that it is higher than the target Ne after the gear shift by a predetermined value N2 (Ne≦target Ne+N2). If the decision is negative (No), the engine revolution speed Ne can be concluded to be too high. In this case, the program proceeds to Step S46, in which an auxiliary brake is turned on. More specifically, the exhaust brake 52 is closed to lower the engine revolution speed Ne.

If the decision in Step S44 is positive (Yes), on the other hand, the engine revolution speed Ne can be concluded to be not so high. In this case, the program proceeds to Step S48, in which the auxiliary brake is turned off, and the program proceeds to Step S50.

If the target Ne is directly given as a command to the engine 1 for control such that the engine revolution speed Ne is adjusted to the target Ne, it takes time for the engine revolution speed Ne to reach the target Ne or a deviation may be left between the engine revolution speed Ne and the target Ne, depending on the engine characteristics. In Step S50, therefore, a command is issued to correct the target Ne, and the engine is controlled so that the corrected target Ne is obtained. Thus, the engine revolution speed Ne can be controlled to be equal to the target Ne without a deviation in a short time.

If the decision in Step S42 is positive (Yes), that is, if it is concluded that the engine revolution speed Ne is equal to or near the target Ne after the gear shift or that the engine revolution speed Ne is substantially synchronous with the target Ne for the gear stage after the gear shift, on the other hand, the program proceeds to Step S52, in which the auxiliary brake is turned off. In Step S54, it is determined whether or not a predetermined period t6 has elapsed since the start of the Ne-F/B control.

If the decision in Step S54 is negative (No), that is, before the lapse of the predetermined period t6, a command for the target Ne is issued in Step S56. If the decision is positive (Yes), that is, after the lapse of the predetermined period t6, or if the decision in Step S40 is negative (No), that is, after the lapse of the predetermined period t5, the Ne-F/B control is terminated, and the program proceeds to Step S28 of FIG. 2.

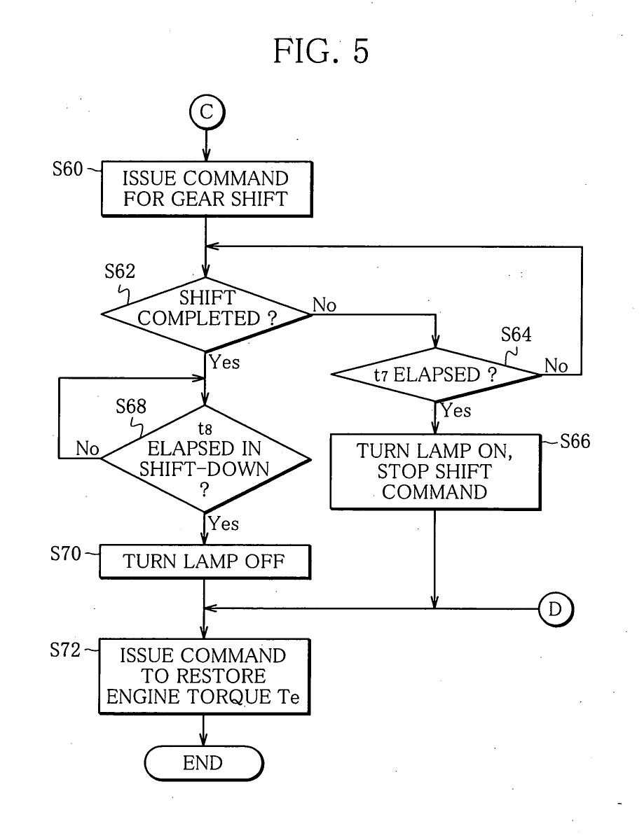

In Step S28, the auxiliary brake is turned off again, and the program proceeds to Step S60 of FIG. 5.

In Step S60, a command for gear shift (gear engagement) is issued, based on the conclusion that the engine revolution speed Ne is equal to or near the target Ne for the gear stage after the gear shift. If the engine revolution speed Ne is substantially synchronous with the target Ne for the gear stage after the gear shift, the gears should be able to engage smoothly without disconnection of the clutch unit 3. In this case, therefore, the gear shift (gear engagement) is performed with the gear shift unit 64 without disconnecting the clutch unit 3, that is, without disconnecting the flywheel 10 and the clutch plate 12 from each other.

In Step S62, it is determined whether or not the gear shift is completed. Based on the information from the gear position sensor 68, in this case, it is determined whether or not the gear shift is achieved so that the gear stage is switched over to a gear stage after the gear shift. If the decision is negative (No), that is, if it is concluded that the gear shift is not achieved, the program proceeds to Step S64, in which a command for gear shift is issued. Thereafter, it is determined whether or not a predetermined period t7 has elapsed. The predetermined period t7, like the predetermined period t3, is a time that exceeds the response delay of the shift fork, for example. Normally, the gears should be engaged before the lapse of the predetermined period t7. If the decision is negative (No), that is, before the lapse of the predetermined period t7, therefore, the determination of Step S62 is continued to wait the engagement of the gears.

If the decision in Step S64 is positive (Yes), that is, if the predetermined period t7 is concluded to have elapsed, on the other hand, the gear shift itself may be supposed to be unattainable for some reason. In this case, therefore, the transmission 4 is concluded to be out of order, whereupon the program proceeds to Step S66, in which the issuance of the command for shift is stopped, and the warning lamp 83 is turned on to inform the driver of the trouble.

If the decision in Step S62 is positive (Yes), that is, if the gear shift is concluded to have been completed, the program proceeds to Step S68.

In Step S68, it is determined whether or not a predetermined period t8 has elapsed in the case of shift-down. If the decision is negative (No), the lapse of the predetermined period t8 is awaited. If the decision is positive (Yes), on the other hand, the program proceeds to Step S70.

In Step S70, the warning lamp 83 is kept off with the gear shift is performed without problems and completed. Then, in following Step S72, a command is issued to restore the engine torque Te, having been changed in Step S10, in response to the completion of the gear shift, and the engine control is returned to a normal control state to restore the engine torque Te.

In the case of the shift-down (shift-down in a state where an accelerator is not depressed and other than a kick-down shift), the engine torque Te is increased to raise the engine revolution speed Ne. If the command is issued to restore the engine torque Te immediately after the gear shift (gear engagement) is performed in this state, the engine torque increase control is stopped to cause the engine torque Te to change suddenly, so that the gears may possibly be disengaged. In the case of the shift-down, therefore, it is determined whether or not the predetermined period t8 has elapsed in Step S68. If the decision is positive (Yes), that is, after the lapse of the predetermined period t8, the command to restore the engine torque Te is issued in Step S72 following Step S70. Thus, the engine torque Te is restrained from changing suddenly, so that gear disengagement is prevented.

In the case of shift-up, moreover, the engine revolution speed Ne is reduced, so that the engine torque Te never increases. Therefore, the gears can never be disengaged even if the engine torque Te is restored immediately after the gear shift (gear engagement) is performed. Thus, in the case of shift-up, the program proceeds to Step S72 without awaiting the lapse of the predetermined period t8, whereupon the command is issued at once to restore the engine torque Te.

A series of clutchless shift control operations is finished in this manner.

The following is a description of a second embodiment.

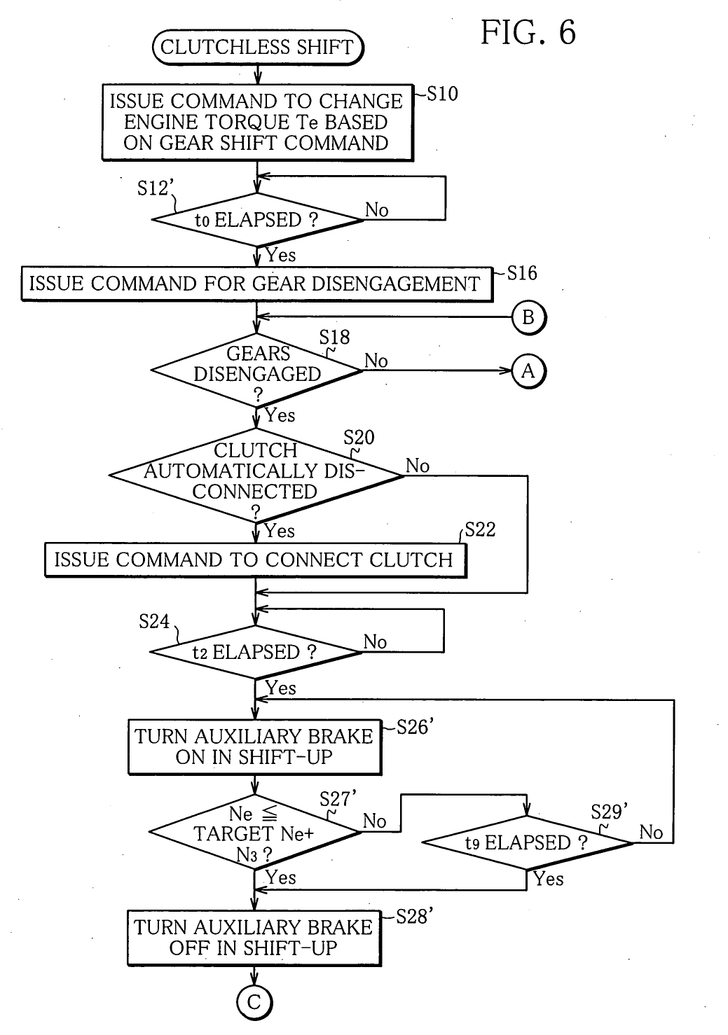

Referring to FIG. 6, there is shown a flowchart illustrating a control routine of clutchless shift control according to the second embodiment of the present invention. The second embodiment will now be described with reference to this flowchart. Same step numbers are used to designate the same portions as those of the first embodiment, and a description of those portions will be omitted. Only those portions which are different from the counterparts of the first embodiment will be described in the following.

In Step S12′ following Step S10, it is determined whether or not a predetermined period t0 has elapsed since the change of the engine torque Te based on a gear shift command. More specifically, the engine torque Te is obtained, and the fuel injection quantity is changed by controlling the control rack so that the engine torque Te can be obtained. If the predetermined period to elapses thereafter, the value of the clutch torque Tcl can be concluded to have reached 0 (zero) or near 0. If the decision is positive (Yes), that is, if the predetermined period t0 is concluded to have elapsed, the program proceeds to Step S16, in which the command for gear disengagement is issued. Also in this case, the gears should be able to be easily disengaged without shock even though the clutch unit 3 is not disconnected.

If the decision in Step S12′ is negative (No), that is, if the predetermined period to is not concluded to have elapsed, on the other hand, the lapse of the predetermined period t0 is awaited.

After Steps S16 to S24 are executed, in Step S26′, simple F/B control is performed in place of the aforesaid Ne-F/B control of FIG. 4.

More specifically, in the case of shift-up, the auxiliary brake is turned on in Step S26′, and it is determined in Step S27′ whether or not the engine revolution speed Ne is within a revolution speed range such that it is higher than the target Ne for a gear stage after the gear shift by a predetermined value N3 (Ne≦target Ne+N3). If the decision is negative (No), the engine revolution speed Ne can be concluded to be too high. In this case, the program returns via Step S29′ to Step S26′, in which the auxiliary brake is kept on, i.e. the exhaust brake 52 is closed so that the engine revolution speed Ne continues to lower.

If the decision in Step S27′ or Step S29′ is positive (Yes), on the other hand, it is concluded that the engine revolution speed Ne is within the revolution speed range in which it is higher than the target Ne for the gear stage after the gear shift by the predetermined value N3 and that the engine revolution speed Ne is substantially synchronous with the target Ne for the gear stage after the gear shift. Thereupon, the auxiliary brake is turned off, and the program proceeds to Step S30 and the subsequent steps of FIG. 3.

According to the transmission control apparatus for the mechanical transmission according to the present invention, as described above, the engine torque Te is obtained from the aforesaid equation (5) so that the value of the clutch torque Tcl of the clutch 3 is 0 (zero) or near 0, and the gears are disengaged under the engine torque Te without connecting or disconnecting the clutch unit 3. Thus, the gear shift time can be shortened so that the gear shift can be quickly achieved without undergoing a shock attributed to gear disengagement.

After the gear disengagement, moreover, the gears are engaged with the engine revolution speed Ne substantially synchronous with the target Ne for the gear stage after the gear shift, and therefore, the gear engagement can be carried out smoothly without connecting or disconnecting the clutch unit 3.

If the engine torque Te is not obtained correctly from the equation (5) or if the rack position sensor 9 is out of order, the clutch unit 3 is disconnected for the gear shift as usual, whereby the gear disengagement and gear engagement can be performed securely.

In the embodiments described above, the clutchless shift control is performed in response to the gear shift command for the automatic gear shift mode. Alternatively, however, the clutchless shift control may be performed in response to a gear shift command that is outputted in accordance with the driver's gear shift operation, for example. If clutch pedal operation is carried out by the driver, in this case, the clutch should only be connected and disconnected with the pedal operation performed with priority.

According to the foregoing embodiments, moreover, the diesel engine is used as an engine type, and the fuel injection quantity is controlled by the fuel injection pump 6 for use as control means for the engine torque Te and the engine revolution speed Ne. Alternatively, however, the engine type may be a gasoline engine, for example, and the engine may be configured so that the engine torque Te and the engine revolution speed Ne can be controlled by adjusting the air intake rate, quantity of fuel injection by a fuel injection valve, ignition timing, etc.

1. A transmission control method for a mechanical transmission, capable of transmitting an output of an internal combustion engine to wheels through a friction clutch by performing automatic multistage speed change, comprising:
a step (a) of controlling an engine torque generated by the internal combustion engine in response to a request for a gear shift of the mechanical transmission so that the value of a transfer torque of the friction clutch is 0 or near 0;
a step (b) of allowing the gear shift of the mechanical transmission when the engine torque is controlled so that the value of the transfer torque is 0 or near 0 in said step (a); and
a step (c) of disengaging and engaging gears with the clutch kept connected when the gear shift is allowed in said step (b).

2. A transmission control method for a mechanical transmission according to claim 1, wherein said step (c) includes a sub-step (c1) of changing an engine revolution speed of the internal combustion engine after the gear disengagement is performed with the clutch kept connected and a sub-step (c2) of performing the gear engagement for a gear stage after the gear shift with the clutch kept connected when the engine revolution speed is substantially synchronous with a gear revolution speed for the gear stage after the gear shift.

3. A transmission control method for a mechanical transmission according to claim 1 or 2, wherein the applicable mechanical transmission is configured so that said friction clutch can be automatically connected and disconnected, and the step (c) includes automatically disconnecting the friction clutch to disengage and engage the gears if gear disengagement is not executed after a command for gear disengagement is issued.

4. A transmission control method for a mechanical transmission according to claim 1, wherein said step (a) includes obtaining a changed engine torque such that the value of the transfer torque is 0 or near 0 in accordance with a first motion equation for a range from the internal combustion engine to the friction clutch and a second motion equation for a range from the friction clutch to each wheel and a position on an axle shaft of a vehicle, indicating the changed engine torque, and controlling the internal combustion engine so that the changed engine torque is generated.

5. A transmission control method for a mechanical transmission according to claim 4, wherein said first motion equation is transformed on condition that an engine rotation angle acceleration on the axle shaft is equal to an axle shaft rotation angle acceleration on the axle shaft, and said step (a) includes obtaining the changed engine torque in accordance with the transformed first motion equation so that the value of the transfer torque is 0.

6. A transmission control method for a mechanical transmission according to claim 4, wherein said second motion equation is transformed on condition that an engine rotation angle acceleration on the axle shaft is equal to an axle shaft rotation angle acceleration on the axle shaft, and said step (a) includes obtaining the changed engine torque in accordance with the transformed second motion equation so that the value of the transfer torque is 0.

7. A transmission control method for a mechanical transmission according to claim 4, wherein said friction clutch has a flywheel and a clutch plate capable of being connected to and disconnected from the flywheel, a motion equation for a range from the internal combustion engine to the flywheel is used as the first motion equation, and a motion equation for a range from the clutch plate to each wheel and a position on the axle shaft is used as the second motion equation.

8. A transmission control method for a mechanical transmission according to claim 4, wherein said step (a) includes concluding that the value of the transfer torque is 0 or near 0 after the lapse of a predetermined period since the indication of the changed engine torque.

9. A transmission control method for a mechanical transmission according to claim 1, wherein said internal combustion engine includes a fuel injection pump unit having a control rack for adjusting a fuel injection quantity, and the step (a) includes controlling the control rack, thereby controlling the engine torque.

10. A transmission control method for a mechanical transmission according to claim 9, wherein said step (b) includes determining whether or not the value of the transfer torque is 0 or near 0 based on the position of the control rack.

11. A transmission control method for a mechanical transmission according to claim 2, wherein said internal combustion engine has an auxiliary brake, and said sub-step (c1) includes actuating the auxiliary brake if the engine revolution speed of the internal combustion engine exceeds an upper limit value of a predetermined revolution speed range including a target engine revolution speed corresponding to the gear revolution speed.

12. A transmission control method for a mechanical transmission according to claim 2, wherein said sub-step (c1) includes correcting a target engine revolution speed corresponding to the gear revolution speed in accordance with the characteristics of the internal combustion engine.

13. A transmission control method for a mechanical transmission according to claim 1, wherein said step (c) includes issuing a command to restore the engine torque after the lapse of a predetermined period since the start of gear engagement when a gear shift from a high-speed stage to a low-speed stage of the mechanical transmission is required by the gear shift request.

14. A transmission control method for a mechanical transmission according to claim 2, wherein said internal combustion engine has an auxiliary brake, and said sub-step (c1) includes actuating the auxiliary brake if the engine revolution speed of the internal combustion engine exceeds an upper limit value of a predetermined revolution speed range including a target engine revolution speed corresponding to the gear revolution speed when a gear shift from a low-speed stage to a high-speed stage of the mechanical transmission is required by the gear shift request.

15. A transmission control apparatus for a mechanical transmission, capable of transmitting an output of an internal combustion engine to wheels through a friction clutch by performing automatic multistage speed change, comprising:
engine torque control means for controlling an engine torque generated by the internal combustion engine so that the value of a transfer torque of the friction clutch is 0 or near 0 when a gear shift of the mechanical transmission is required;
gear shift allowing means for allowing the gear shift of the mechanical transmission when the engine torque is controlled by the engine torque control means so that the value of the transfer torque is 0 or near 0; and
gear shift executing means for disengaging and engaging gears with the clutch kept connected when the gear shift is allowed by the gear shift allowing means.

16. A transmission control apparatus for a mechanical transmission according to claim 15, which further comprises engine revolution speed detecting means for detecting an engine revolution speed of the internal combustion engine and gear revolution speed detecting means for detecting a gear revolution speed for a gear stage after the gear shift, and wherein said gear shift executing means changes the engine revolution speed of the internal combustion engine after the gear disengagement is performed with the clutch kept connected and performs the gear engagement for the gear stage after the gear shift with the clutch kept connected when the engine revolution speed is substantially synchronous with the gear revolution speed for the gear stage after the gear shift.

17. A transmission control apparatus for a mechanical transmission according to claim 15 or 16, wherein said friction clutch is configured to be able to be automatically connected and disconnected, and the gear shift executing means automatically disconnects the friction clutch to disengage and engage the gears if gear disengagement is not executed after a command for gear disengagement is issued.

18. A transmission control apparatus for a mechanical transmission according to claim 15, wherein said friction clutch has a flywheel and a clutch plate capable of being connected to and disconnected from the flywheel, and said engine torque control means obtains a changed engine torque such that the value of the transfer torque is 0 or near 0 in accordance with a first motion equation for a range from the internal combustion engine to the flywheel and a second motion equation for a range from the friction clutch to each wheel and a position on an axle shaft of a vehicle and controls the internal combustion engine so that the changed engine torque is generated.

19. A transmission control apparatus for a mechanical transmission according to claim 15, wherein said internal combustion engine includes a fuel injection pump unit having a control rack for adjusting a fuel injection quantity, and said engine torque control means controls the control rack, thereby controlling the engine torque.

20. A transmission control apparatus for a mechanical transmission according to claim 16, wherein said internal combustion engine has an auxiliary brake, and said gear shift executing means actuates the auxiliary brake if the engine revolution speed of the internal combustion engine exceeds an upper limit value of a predetermined revolution speed range including a target engine revolution speed corresponding to the gear revolution speed.
